(19) United States
(12) Patent Application Publication
(10) Pub. No.: US 2010/0180783 A1
(43) Pub. Date: Jul. 22, 2010

(54) METHOD FOR PROVIDING A LATERAL PROTECTION FOR THE SELF-ADHESIVE UNDERCOATING PLASTIC SHEET OF A COATING (METAL-BACK PRINTING BLANKET) OF A TYPOGRAPHIC PRINTING ROLL

(75) Inventors: Gianpietro Invernizzi, Lodi (IT); Fausto Zeni, Secugnago (IT)

Correspondence Address: Clements Bernard PLLC, 1901 Roxborough Road, Suite 250, Charlotte, NC, 28211, US

(73) Assignee: TRELLEBORG ENGINEERED SYSTEMS ITALY S.P.A., Milan (IT)

(21) Appl. No.: 12/667,547

(22) PCT Filed: Jul. 4, 2008
(86) PCT No.: PCT/IB08/52698

§ 371 Date: Jan. 4, 2010

(30) Foreign Application Priority Data
Jul. 6, 2007 (IT) MI2007A001346

(51) Int. Cl. B41C 3/08; B29C 65/50

(52) U.S. Cl. 101/401.1; 156/304.1

(57) ABSTRACT

Described herein is a method for providing a metal-back printing blanket with self-adhesive plastic sheet, made to adhere to the metal layer of the printing blanket with adhesive of the PSA (Pressure Sensitive Adhesive) type, comprising a step of sealing one or more edges of the plastic sheet via application of an adhesive tape on said edges.

### FIELD OF APPLICATION OF THE INVENTION

The present invention relates to a method for providing a lateral protection for the self-adhesive undercoating plastic sheet of a coating (metal-back printing blanket) of a typographic printing roll.

### STATE OF THE ART

Machines for typographic printing are made up of a number of rolls, some of which simply carry out a driving function in regard to the paper that is passing through, whilst others are involved, in particular, in the printing process. Amongst the latter rolls, at least one performs the function of taking the ink from the printing plate or matrix and transferring it to the paper. The roll or cylinder that is to receive the ink from the plate and transfer it to the paper is made of steel coated with a rubberized fabric referred to in the technical sector as “offset printing blanket”, which must guarantee that the ink is taken up efficiently from the printing matrix with a consequent good transfer of the ink itself to the paper to be printed.

An offset printing blanket is typically made up of different layers, generally of rubber and fabric: its outer part (top part) is made of rubber, and the bottom part in contact with the printing roll is generally made of fabric.

In the case, instead, of a coating referred to in the technical sector and in what follows as “metal-back printing blanket”, the bottom part in contact with the printing roll is constituted by a metal layer made of stainless steel.

The metal-back printing blanket is wound around the steel roll, which envisages a transverse slit, referred to as <<gap>>, within which the terminal edges of the metal base of the metal-back printing blanket are inserted and fixed.

The printing roll and the metal-back printing blanket are subject to phenomena of corrosion and wear due to mutual rubbing and in particular to the corrosive action of the chemical products used in the printing process and in the steps of cleaning after use.

In order to overcome the effects of corrosion and wear, it is known from the U.S. Pat. No. 6,912,955 to coat the bottom surface of the metal-back printing blanket, which is to come into contact with the printing roll, with a plasma treatment.

It is likewise known to insert between the metal layer of the metal-back printing blanket and the surface of the printing roll a sheet of plastic material, which can be wound around the printing roll, or else fixed on the bottom surface of the metal layer of the metal-back printing blanket. Fixing is obtained with an adhesive of the PSA (Pressure Sensitive Adhesive) type.

The above adhesive, however, presents problems due to the fact that it does not resist effectively the solvents used in the processes of printing and above all of washing of the surface, in addition to not having sufficient adhesion at temperatures higher than 60° C.

The solvent tends to penetrate from the edges of the plastic sheet and corrode the adhesive, with formation of bubbles and detachment of the undercoating of the metal layer.

### SUMMARY OF THE INVENTION

Consequently, the purpose of the present invention is to overcome the aforesaid drawbacks and indicate a method for providing a lateral protection for the self-adhesive undercoating plastic sheet of a metal-back printing blanket for a typographic printing roll, which prevents penetration of the solvents and guarantees perfect adhesion of the plastic sheet to the metal-back printing blanket itself.

The subject of the present invention is a method for providing a coating for a typographic printing roll, said coating, referred to as “metal-back printing blanket”, comprising at least one metal layer, one or more upper layers, and a sheet of plastic material on the bottom surface of the metal layer, said sheet of plastic material being made to adhere to said metal layer with an adhesive of the PSA acrylic type, said method being characterized in that it comprises a step of sealing one or more edges of the sheet of plastic material via application of an adhesive material on said edges, which straddles both the outer edge of the plastic sheet and a strip of the adjacent metal layer.

A particular subject of the present invention is a method for providing a metal-back printing blanket with a self-adhesive plastic sheet, and a corresponding metal-back printing blanket thus obtained, as will be described more fully in the claims, which form an integral part of the present description.

### BRIEF DESCRIPTION OF THE FIGURES

Further purposes and advantages of the present invention will emerge clearly from the ensuing detailed description of an example of embodiment thereof (and of its variants) and from the annexed plate of drawings, which is provided purely by way of explanatory and non-limiting example, and in which:

FIG. 1 shows a cross-sectional side view of the metal-back printing blanket provided with plastic sheet, forming the subject of the present invention.

### DETAILED DESCRIPTION OF EXAMPLES OF EMBODIMENT

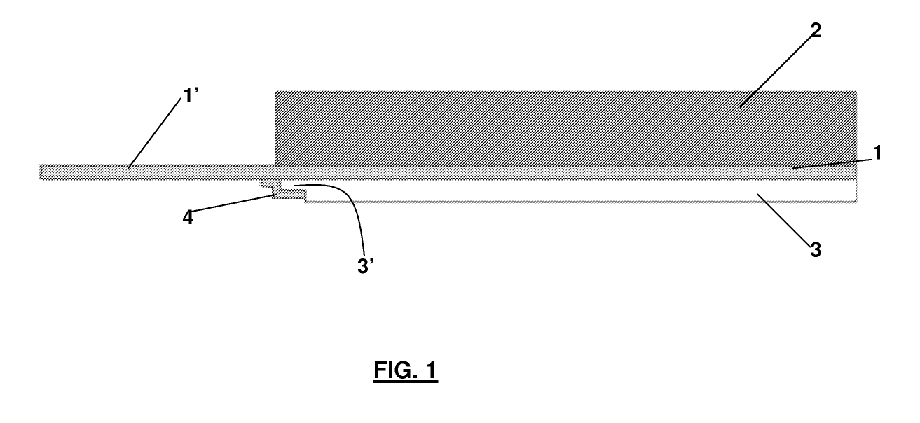

With reference to FIG. 1, the reference number 1 designates the metal layer of the metal-back printing blanket, whilst the reference number 2 designates the set of the upper layers of the metal-back printing blanket (one or more layers) obtained with well-known techniques.

The reference number 3 designates a sheet of plastic material, for example made of polyester, fixed on the bottom surface of the metal layer 1 of the metal-back printing blanket. Preferably, the sheet 3 occupies a major part of the bottom surface of the metal layer 1, with the exclusion of the edge 1′, which is folded back and inserted in the gap of the printing roll not represented in the FIGURE.

The sheet of plastic material 3 is made to adhere in a known way to the metal layer 1 with an adhesive of the acrylic PSA (Pressure Sensitive Adhesive) type.

Then, according to the main aspect of the present invention, one or more edges of the plastic sheet 3 are sealed to the metal layer 1 by means of an adhesive material, which, in this example of embodiment, is an adhesive tape 4 applied so that it straddles both the outer edge of the plastic sheet 3 and a strip of the adjacent metal layer 1.

Preferably, the adhesive tape is provided with thermoplastic or thermosetting glue, which is able to undergo vulcanizing and cross-linking, and proves resistant to the solvents typically used and to the high temperatures, higher than 60° C., which can develop during normal use of the blanket.

The adhesive tape can be constituted, for example, by a support of plastic material (polyester, polyvinyl chloride, polypropylene, polyurethane, PTFE), possibly coated with a metal or rubber layer, which improves its resistance to solvents.

The glue of the adhesive tape can comprise, for example, one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives, etc.

In accordance with another example of embodiment, the adhesive tape 4 can also present as fluid or gel layer with a material composition comprising one or more materials, for example, chosen from amongst the ones referred to above, which is spread or applied with a purposely provided tool, for example a paintbrush, a spatula, a roller, a gun or by spraying.

Preferably, the adhesive tape 4 is applied at least to the edge of the plastic sheet set at the so-called “leading edge” of the metal-back printing blanket, i.e., at the edge that is in front with respect to the direction of rotation of the printing roll, at one side of the gap of the printing roll, since this is the edge of the plastic sheet in which there occurs principally the undesirable phenomenon of penetration of the solvent.

Obviously, the tape can appropriately be applied on a number or all of the sides of the plastic sheet, on the side edges and on the so-called “trailing edge”, i.e., the edge that is at the back with respect to the direction of rotation of the printing roll, at the other side of the gap of the printing roll.

In order to prevent the thickness of the adhesive tape 4 from creating an undesirable overall thickening of the metal-back printing blanket in the points in which it is applied, a thickening that could adversely affect proper rotation of the printing roll and a correct printing process, a prior milling is preferably made of the edge 3′ of the plastic sheet 3 on which the tape will be applied, so as to render the overall thickness of the stretch that comprises the edge of the plastic sheet and the adhesive tape uniform.

Variants are possible to the non-limiting example described, without this implying any departure from the sphere of protection of the present invention, said variants comprising all the embodiments that are equivalent for a person skilled in the branch.

The advantages deriving from the application of the present invention emerge clearly.

The application of the adhesive tape 4 prevents penetration of the solvents between the plastic sheet and the metal layer, and guarantees perfect adhesion of the plastic sheet to the metal of the metal-back printing blanket.

From the above description, the person skilled in the branch is able to reproduce the subject of the invention without introducing any further constructional details.

1. A method for providing a coating for a typographic printing roll, said coating, referred to in the following as “metal-back printing blanket”, comprising at least one metal layer, one or more upper layers, and a sheet of plastic material on the bottom surface of the metal layer, said sheet of plastic material being made to adhere to said metal layer with an adhesive of the PSA (Pressure Sensitive Adhesive) type;
said method comprising a step of sealing one or more edges of the sheet of plastic material via application of an adhesive material on said edges, which straddles both the outer edge of the plastic sheet and a strip of the adjacent metal layer.

2. The method according to claim 1, wherein said adhesive material is an adhesive tape.

3. The method according to claim 2, wherein said adhesive tape comprises a support of plastic material, for example made of polyester, polyvinyl chloride, polypropylene, polyurethane, PTFE, possibly coated with a metal or rubber layer.

4. The method according to claim 2, wherein said adhesive tape is provided with thermoplastic or thermosetting glue.

5. The method according to claim 4, wherein said glue comprises one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives.

6. The method according to claim 1, wherein said adhesive material is a fluid or gel layer.

7. The method according to claim 1, wherein said adhesive tape is applied at least to the edge of the plastic sheet set at the leading edge of the coating.

8. The method according to claim 1, further comprising a step of preventive milling of one or more edges of said plastic sheet on which the tape will be applied so as to render the overall thickness of the stretch that comprises the edge of the plastic sheet and the adhesive tape uniform.

9. A metal-back printing blanket for a typographic printing roll, comprising at least one metal layer, one or more upper layers, and a sheet of plastic material on the bottom surface of the metal layer, said sheet of plastic material being made to adhere to said metal layer with an adhesive of the PSA type, said metal-back printing blanket comprising an adhesive material applied on one or more edges of the plastic sheet, which straddles both the outer edge of the plastic sheet and a strip of the adjacent metal layer (1).

10. The metal-back printing blanket according to claim 9, wherein said adhesive material is an adhesive tape.

11. The metal-back printing blanket according to claim 10, wherein said adhesive tape comprises a support of plastic material, for example made of polyester, polyvinyl chloride, polypropylene, polyurethane, PTFE, possibly coated with a metal or rubber layer.

12. The metal-back printing blanket according to claim 10, wherein said adhesive tape is provided with thermoplastic or thermosetting glue.

13. The metal-back printing blanket according to claim 12, wherein said glue comprises one or more of the following materials: thermoplastic polyurethane, polyvinyl chloride, copolymers with vinyl acetate, thermosetting polyurethane, polyester, polyamide, polyolephin, phenolic resins, epoxy adhesives, polyurethane adhesives, polyacrylic adhesives.

14. The metal-back printing blanket according to claim 9, wherein said adhesive tape is a fluid or gel layer.

15. The metal-back printing blanket according to claim 9, wherein said adhesive tape is present at least on the edge of the plastic sheet set at the leading edge of the coating.

16. The metal-back printing blanket according to claim 9, wherein said one or more edges of said sheet of plastic material are milled in an area corresponding to the points on which the tape is applied so as to render the overall thickness of the stretch that comprises the edge of the plastic sheet and the adhesive tape uniform.
